(19) United States
(12) Patent Application Publication
(10) Pub. No.: US 2025/0139938 A1
(43) Pub. Date: May 1, 2025

(54) IMAGE PROCESSING DEVICE AND IMAGING APPARATUS

(71) Applicant: SHARP KABUSHIKI KAISHA, Sakai City (JP)

(72) Inventor: Tatsuya Hara, Sakai City (JP)

(21) Appl. No.: 18/921,304

(22) Filed: Oct. 21, 2024

(30) Foreign Application Priority Data
Oct. 30, 2023 (JP) 2023-185133

(51) Int. Cl. G06V 10/70; G06T 5/90

(52) U.S. Cl. CPC G06V 10/70; G06T 5/90; G06T 2207/10144; G06T 2207/20208

(57) ABSTRACT

An image processing device comprises a recognition unit configured to recognize a flower image included in an image, and a determination unit configured to determine to perform high-dynamic-range rendering when the flower image has been recognized by the recognition unit.

### CROSS-REFERENCE TO RELATED APPLICATION

The present application claims priority from Japanese Application JP2023-185133, the content of which is hereby incorporated by reference into this application.

### BACKGROUND OF THE INVENTION

### 1. Field of the Invention

The present disclosure relates to an image processing device and an imaging apparatus.

### 2. Description of the Related Art

International Publication No. 2022/130846 discloses an information processing device. The information processing device acquires learning data and a test image. With the learning data, learning of image processing, such as SDR-HDR conversion, is performed to generate an image conversion model. With the image conversion model, an inferred image is generated from the test image. The inferred image is evaluated to calculate its evaluation value. Whether to perform re-learning is determined based on the evaluation value. The materials of a subject appearing in the test image are recognized. The recognized materials include a flower. In accordance with a combination of the recognized materials, an object appearing in the test image is recognized. The shooting environment of a captured image to be used for re-learning is determined based on the recognized object (paragraphs 0013, 0060, 0062, 0064, 0069, 0072, 0077, 0082, 0084, 0085, and 0118).

### SUMMARY OF THE INVENTION

The flower image included in the image has high brightness. Hence, the color of the flower image tends to be saturated. An effective way to avoid such color saturation in the flower image is lowering an exposure when the flower is imaged. However, lowering the exposure to avoid the color saturation makes the whole image too dark.

One aspect of the present disclosure has been made in view of this problem. It is an object of one aspect of the present disclosure to provide an image processing device and an imaging apparatus that can avoid color saturation in a flower image included in an image while keeping the whole image at proper brightness.

An image processing device according to a first aspect of the present disclosure is provided with the following: a recognition unit configured to recognize a flower image included in an image; and a determination unit configured to determine to perform high-dynamic-range rendering when the flower image has been recognized by the recognition unit.

An imaging apparatus according to a second aspect of the present disclosure is provided with the following: the image processing device according to the first aspect of the present disclosure; an imagining unit configured to perform imaging; and an autoexposure unit configured to regulate an exposure in the imaging to cause the imagining unit to capture a plurality of images that are to undergo the high-dynamic-range rendering.

### BRIEF DESCRIPTION OF THE DRAWINGS

FIG. 1 is a block diagram of an imaging apparatus according to a first embodiment; and

FIG. 2 is a flowchart showing a process that is performed by the imaging apparatus according to the first embodiment.

### DETAILED DESCRIPTION OF THE INVENTION

The embodiment of the present disclosure will be described with reference to the drawings. It is noted that identical or equivalent constituents will be denoted by the same signs throughout the drawings, and the description of redundancies will be omitted.

### 1 First Embodiment

### 1.1 Imaging Apparatus

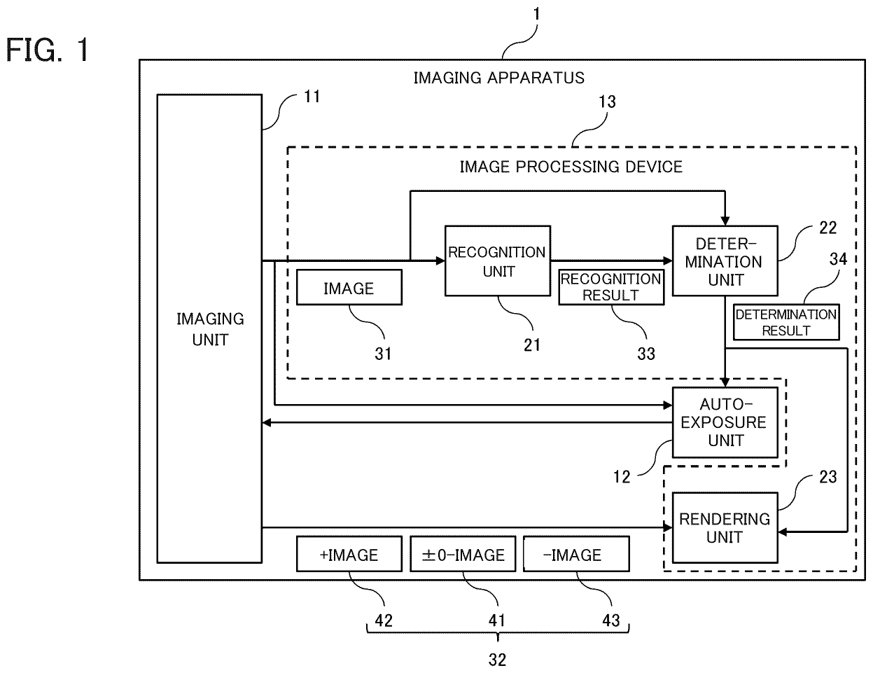

FIG. 1 is a block diagram of an imaging apparatus according to a first embodiment.

The imaging apparatus, 1, illustrated in FIG. 1 captures an image through imaging.

As illustrated in FIG. 1, the imaging apparatus 1 is provided with an imagining unit 11, an autoexposure unit 12, and an image processing device 13.

The imagining unit 11 captures an image 31 through imaging. The imaging unit 11 is provided with an image sensor.

The autoexposure unit 12 regulates an exposure in the imaging such that the image 31 having proper brightness can be captured. When the image processing device 13 performs high-dynamic-range (HDR) rendering, the autoexposure unit 12 regulates the exposure in the imaging to cause the imagining unit 11 to capture a plurality of images 32 needed for the HDR rendering and having mutually different exposures. The plurality of images 32 are composed of three images: a ±0-image 41 having a proper brightness level; a +image 42 having a higher brightness level than the proper brightness level; and a-image 43 having a lower brightness level than the proper brightness level. The plurality of images 32 may be composed of two images, or four or more images.

The image processing device 13 processes the captured image 31. When the contrast of the image 31 is large, the image processing device 13 causes the autoexposure unit 12 to regulate the exposure in the imaging such that the plurality of images 32 are captured and subjects the plurality of captured images 32 to the HDR rendering to capture an HDR image. In addition, when the contrast of the image 31 is small, upon recognizing a flower image included in the image 31, the image processing device 13 causes the autoexposure unit 12 to regulate the exposure in the imaging such that the plurality of images 32 are captured and subjects the plurality of captured images 32 to the HDR rendering to capture an HDR image. The captured HDR image has a wide dynamic range.

### 1.2 Image Processing Device

As illustrated in FIG. 1, the image processing device 13 is provided with a recognition unit 21, a determination unit 22, and a rendering unit 23.

The recognition unit 21 recognizes the flower image included in the image 31. The recognition unit 21 recognizes the flower image included in the image 31 through, for instance, artificial-intelligence (AI) image analysis.

The determination unit 22 performs a primary determination and a secondary determination. In the primary determination, the determination unit 22 determines whether to perform the HDR rendering in accordance with the contrast of the image 31. In the secondary determination, the determination unit 22 determines whether to perform the HDR rendering in accordance with a recognition result 33 from the recognition unit 21.

The determination unit 22 determines to perform the HDR rendering in the primary determination when the contrast of the image 31 is equal to or greater than a criterion. The determination unit 22 determines not to perform the HDR rendering in the primary determination when the contrast of the image 31 is not equal to or greater than the criterion. For instance, the determination unit 22 determines to perform the HDR rendering in the primary determination when the following conditions are satisfied: a first condition in which the image 31 includes more potions that are extremely bright than a specified volume; and a second condition in which the image 31 includes more portions that are extremely dark than a specified volume. The determination unit 22 determines not to perform the HDR rendering in the primary determination when either the first condition or the second condition is not satisfied.

The determination unit 22 performs the secondary determination upon determining not to perform the HDR rendering in the primary determination. The determination unit 22 determines to perform the HDR rendering in the secondary determination when the flower image included in the image 31 has been recognized by the recognition unit 21. The determination unit 22 determines not to perform the HDR rendering in the secondary determination when the flower image included in the image 31 has not been recognized by the recognition unit 21.

The rendering unit 23 performs the HDR rendering in accordance with a determination result 34 from the determination unit 22. In response to a determination to perform the HDR rendering, the rendering unit 23 subjects the plurality of images 32 to the HDR rendering to capture an HDR image.

The captured HDR image may be converted into a compressed image, such as a JPEG image.

The image processing device 13 is provided with a processor, a memory, and a peripheral circuit. The processor executes an image processing program stored in the memory to cause the processor, memory, and peripheral circuit to operate as the recognition unit 21, determination unit 22, and rendering unit 23. The processing performed by the processor may be, in whole or part, performed by a dedicated circuit.

### 1.3 Process Flow

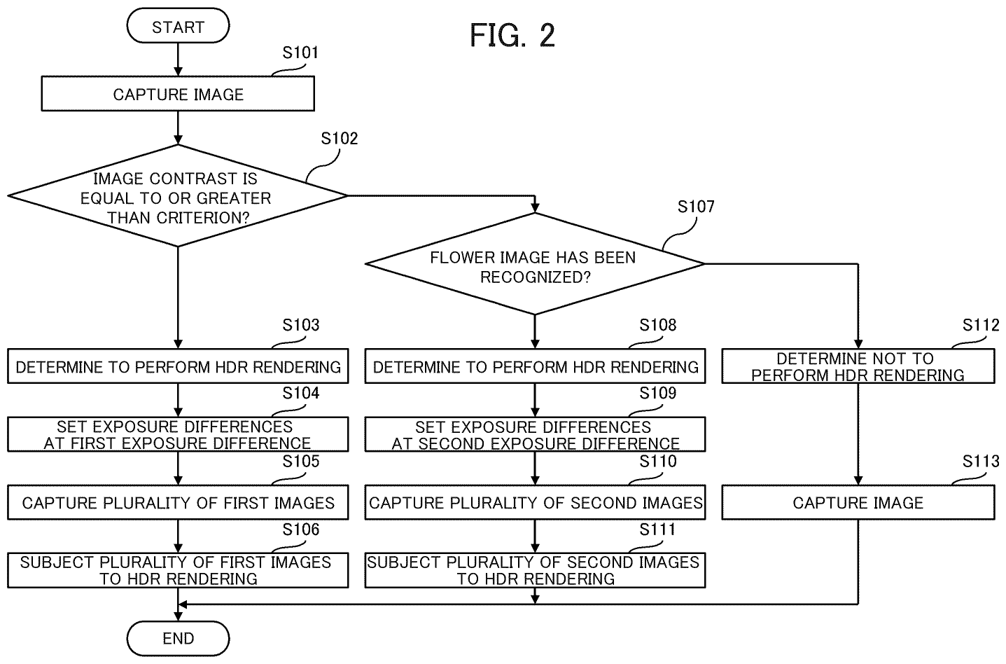

FIG. 2 is a flowchart showing a process that is performed by the imaging apparatus according to the first embodiment.

The imaging device 1 executes Steps S101 to S113 shown in FIG. 2.

In Step S101, the imagining unit 11 captures the image 31 through imaging.

In subsequent Step S102, the determination unit 22 determines whether the contrast of the image 31 is equal to or greater than a criterion. If the determination unit 22 has determined that the contrast of the image 31 is equal to or greater than the criterion, Steps S103 to S106 are executed. If the determination unit 22 has determined that the contrast of the image 31 is not equal to or greater than the criterion, Step S107 is executed.

In Step S103, the determination unit 22 determines to perform the HIDR rendering.

In Step S104, the autoexposure unit 12 sets the exposure differences of the plurality of images 32 at a first exposure difference.

In Step S105, the imagining unit 11 performs exposure bracketing to capture a plurality of first images having the first exposure difference.

In Step S106, the rendering unit 23 subjects the plurality of first images to the HDR rendering.

Through Steps S103 to S106, the rendering unit 23 subjects the plurality of first images having the first exposure difference to the HDR rendering if the determination unit 22 has determined to perform the HDR rendering in the primary determination.

In Step S107, the determination unit 22 determines whether the recognition unit 21 has recognized the flower image included in the image 31. If the recognition unit 21 has recognized the flower image included in the image 31, Steps S108 to S111 are executed. If the recognition unit 21 has not recognized the flower image included in the image 31, Steps S112 and S113 are executed.

In Step S108, the determination unit 22 determines to perform the HDR rendering.

In Step S109, the autoexposure unit 12 sets the exposure differences of the plurality of images 32 at a second exposure difference.

In Step S110, the imagining unit 11 performs exposure bracketing to capture a plurality of second images having the second exposure difference.

In Step S111, the rendering unit 23 subjects the plurality of second images to the HDR rendering. Through the foregoing, the image 31 can be avoided from color saturation in its flower image while being kept at proper brightness in whole.

Through Steps S108 to S111, the rendering unit 23 subjects the plurality of first images having the second exposure difference to the HDR rendering if the determination unit 22 has determined to perform the HDR rendering in the secondary determination.

The second exposure difference is smaller than the first exposure difference. The second exposure difference is smaller than the first exposure difference because an exposure difference suitable for the HDR rendering that is performed on the image 31 including the flower image is smaller than an exposure difference suitable for the HDR rendering that is performed on the image 31 having a large contrast.

In Step S112, the determination unit 22 determines not to perform the HIDR rendering.

In Step S113, the imagining unit 11 captures an image.

The present disclosure is not limited to the above-described embodiment. The present disclosure may be replaced with a configuration substantially identical to those described in the above-described embodiment, a configuration that provides the same action and effect as those described in the above-described embodiment, or a configuration that can achieve the same object as those described in the above-described embodiment.

While there have been described what are at present considered to be certain embodiments of the invention, it will be understood that various modifications may be made thereto, and it is intended that the appended claims cover all such modifications as fall within the true spirit and scope of the invention.

What is claimed is:

1. An image processing device comprising:
a recognition unit configured to recognize a flower image included in an image; and
a determination unit configured to determine to perform high-dynamic-range rendering when the flower image has been recognized by the recognition unit.

2. The image processing device according to claim 1, wherein
the determination unit performs a primary determination to determine whether to perform the high-dynamic-range rendering in accordance with a contrast of the image, and
the determination unit determines to perform the high-dynamic-range rendering when having determined not to perform the high-dynamic-range rendering in the primary determination, and when the flower image has been recognized by the recognition unit.

3. The image processing device according to claim 2, comprising
a rendering unit configured to subject a plurality of first images having a first exposure difference to the high-dynamic-range rendering when the determination unit has determined to perform the high-dynamic-range rendering in the primary determination, and to subject a plurality of second images having a second exposure difference to the high-dynamic-range rendering when the determination unit has determined to perform the high-dynamic-range rendering in response to recognition of the flower image by the recognition unit, the second exposure difference being smaller than the first exposure difference.

4. An imaging apparatus comprising:
the image processing device according to claim 1;
an imagining unit configured to perform imaging; and
an autoexposure unit configured to regulate an exposure in the imaging to cause the imagining unit to capture a plurality of images that are to undergo the high-dynamic-range rendering.
